(19) United States
(12) Patent Application Publication
(10) Pub. No.: US 2012/0236045 A1
(43) Pub. Date: Sep. 20, 2012

(54) DISPLAY CONTROL APPARATUS AND DISPLAY CONTROL METHOD

(75) Inventors: Yuki TAMURA, Kawasaki (JP); Yoshiyasu Nakashima, Kawasaki (JP); Yasushi Hara, Yokohama (JP)

(73) Assignee: FUJITSU LIMITED, Kawasaki-shi (JP)

(21) Appl. No.: 13/419,566

(22) Filed: Mar. 14, 2012

(30) Foreign Application Priority Data
Mar. 18, 2011 (JP) 2011-061783

(51) Int. Cl. G09G 5/10

(52) U.S. Cl. 345/690

(57) ABSTRACT

The disclosed method includes: detecting a case where at least both of a condition that a pointer representing a pointing destination by a pointing device is not displayed on one display device of a plurality of display devices and a condition that a window generated by a predetermined program is not displayed on the one display device are satisfied; and upon the detecting, lowering brightness of the one display device. Moreover, another method includes: first detecting a predetermined operation for an active window displayed on any display device; identifying a first display device on which the active window is displayed; second detecting that a pointer representing a pointing destination by a pointing device is not displayed on the first display device after a predetermined period elapsed since the first detecting; and upon the second detecting, carrying out a setting for lowering brightness of the first display device.

### CROSS-REFERENCE TO RELATED APPLICATIONS

This application is based upon and claims the benefit of priority of the prior Japanese Patent Application No. 2011-061783, filed on Mar. 18, 2011, the entire contents of which are incorporated herein by reference.

### FIELD

The present invention relates to a display control technique by a computer.

### BACKGROUND

Recently, as the price of the display device such as a liquid crystal display device falls, a case increases where plural display devices are connected with a computer in order to improve the work efficiency. However, in such a utilization mode, the power consumption is apt to increase.

Typically, even when the plural display devices are utilized, the plural display devices are not always utilized. Namely, the user frequently looks at one display device closely, and does not look at the other display devices, closely.

For example, a technique exists in which the brightness of a display device other than a display device displaying a mouse pointer among the plural display device is lowered. However, as illustrated in FIG. 1, when three display devices are used, there is an inconvenience when a window of a program under work and a mouse point are displayed on a display device 1, and windows whose display contents are referenced by the user are displayed on display devices 2 and 3. In other words, because there is no mouse pointer on the display devices 2 and 3, the brightness of the display devices 2 and 3 is lowered, the reference of the display contents is prevented, and then the usability is lowered. Moreover, operations between windows displayed on different display devices are not considered.

In other words, there is no technique that the energy saving is effectively realized in view of the usability or user' s convenience in a computer connected with plural display devices.

### SUMMARY

A display control method relating to a first aspect include: detecting a case where at least both of a condition that a pointer representing a pointing destination by a pointing device is not displayed on one display device of a plurality of display devices and a condition that a window generated by a predetermined program is not displayed on the one display device are satisfied; and upon the detecting, lowering brightness of the one display device.

A display control method relating to a second aspect include: first detecting a predetermined operation for an active window displayed on any one display device among a plurality of display devices connected to the computer; identifying a first display device on which the active window is displayed; second detecting that a pointer representing a pointing destination by a pointing device is not displayed on the first display device after a predetermined period elapsed since the first detecting; and upon the second detecting, carrying out a setting for lowering brightness of the first display device.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain a problem in a conventional art;

FIG. 2A is a diagram to explain a first embodiment;

FIG. 2B is a diagram to explain the first embodiment;

FIG. 3A is a diagram to explain the first embodiment;

FIG. 3B is a diagram to explain the first embodiment;

FIG. 4 is a functional block diagram of an apparatus relating to the first embodiment;

FIG. 5 is a diagram depicting an example of data stored in a threshold storage unit;

FIG. 6 is a diagram depicting an example of data stored in a visit time storage unit;

FIG. 7 is a diagram depicting an example of data stored in a brightness table storage unit;

FIG. 8 is a diagram depicting an example of data stored in a correspondence table storage unit;

FIG. 9 is a diagram depicting an example of data stored in a viewer registration table storage unit;

FIG. 10 is a diagram depicting an example of data stored in an executed process storage unit;

FIG. 11 is a diagram depicting a processing flow relating to the first embodiment;

FIG. 12 is a diagram depicting a processing flow relating to the first embodiment;

FIG. 13 is a diagram depicting a processing flow relating to the first embodiment;

FIG. 14 is a diagram depicting a processing flow of a processing for obtaining the number of viewer expansions;

FIG. 15 is a diagram depicting an example of data used in the processing for obtaining the number of viewer expansions;

FIG. 16 is a diagram depicting an example of data used in the processing for obtaining the number of viewer expansions;

FIG. 17A is a diagram to explain a second embodiment;

FIG. 17B is a diagram to explain the second embodiment;

FIG. 17C is a diagram to explain the second embodiment;

FIG. 18 is a diagram to explain the second diagram;

FIG. 19 is a functional block diagram of an apparatus relating to the second embodiment;

FIG. 20 is a diagram depicting an example of data stored in the visit time storage unit;

FIG. 21 is a diagram depicting a processing flow relating to the second embodiment;

FIG. 22 is a diagram depicting a processing flow relating to the second embodiment;

FIG. 23 is a diagram depicting a processing flow relating to the second embodiment;

FIG. 24 is a diagram depicting a processing flow relating to the second embodiment;

FIG. 25 is a diagram depicting a processing flow relating to the second embodiment; and

FIG. 26 is a functional block diagram of a computer.

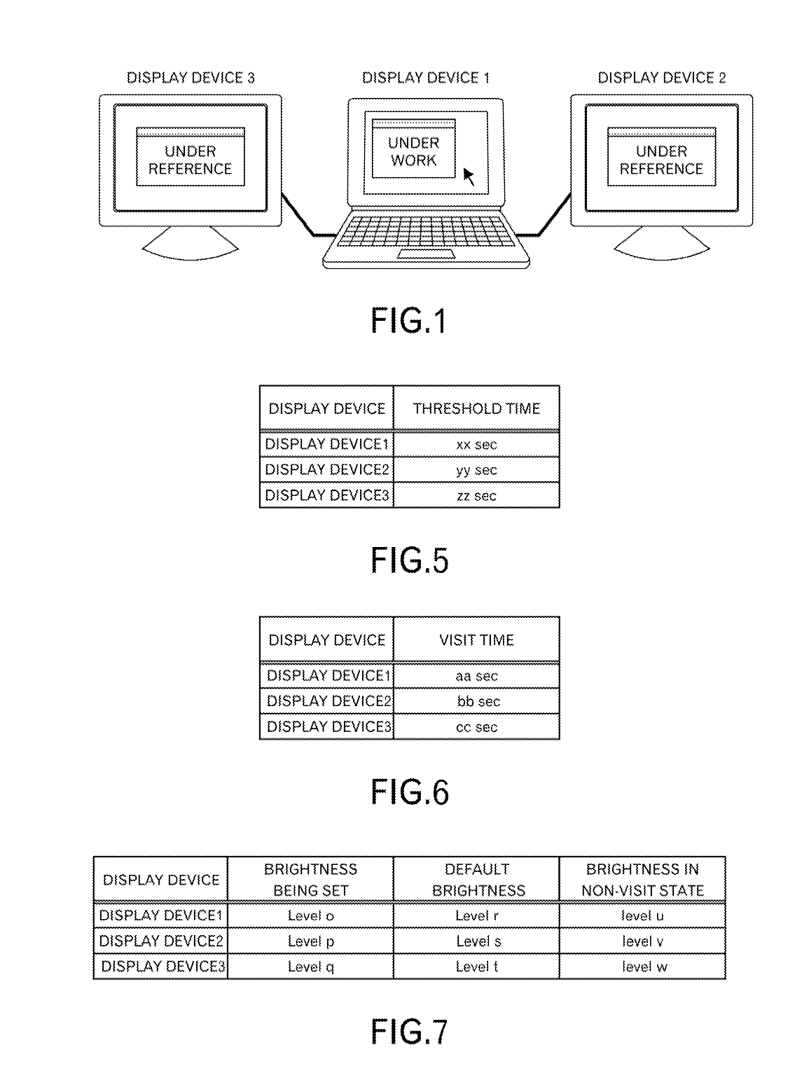

### DESCRIPTION OF EMBODIMENTS

### Embodiment 1

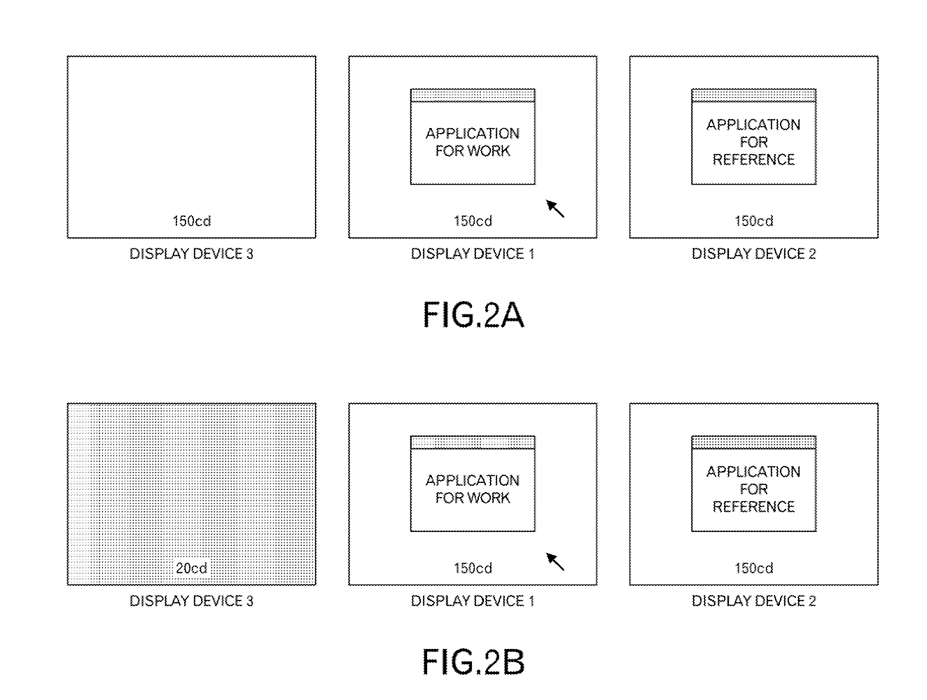

In this embodiment, a display control is carried out as follows: Namely, as illustrated in FIG. 2A, a state is presumed that a window of an application for work and a mouse pointer are displayed on a display device 1, a window of an application for reference is displayed on a display device 2, and no window of the application for work or application for reference is displayed on a display device 3. Then, when this state continues for a predetermined period, as illustrated in FIG. 2B, the brightness of the display device 1 and display device 2 is not lowered. However, the brightness of the display device 3 is lowered from 150 cd [candela] to 20 cd [candela]. Accordingly, the energy saving is realized. Incidentally, because the brightness of the display device 2, which displays the window of the application for reference, is not lowered, the convenience of the user who carries out work while referring to the window of the application for reference is not lowered. Moreover, in this embodiment, lowering the brightness includes stopping output of display data to the display device from the computer.

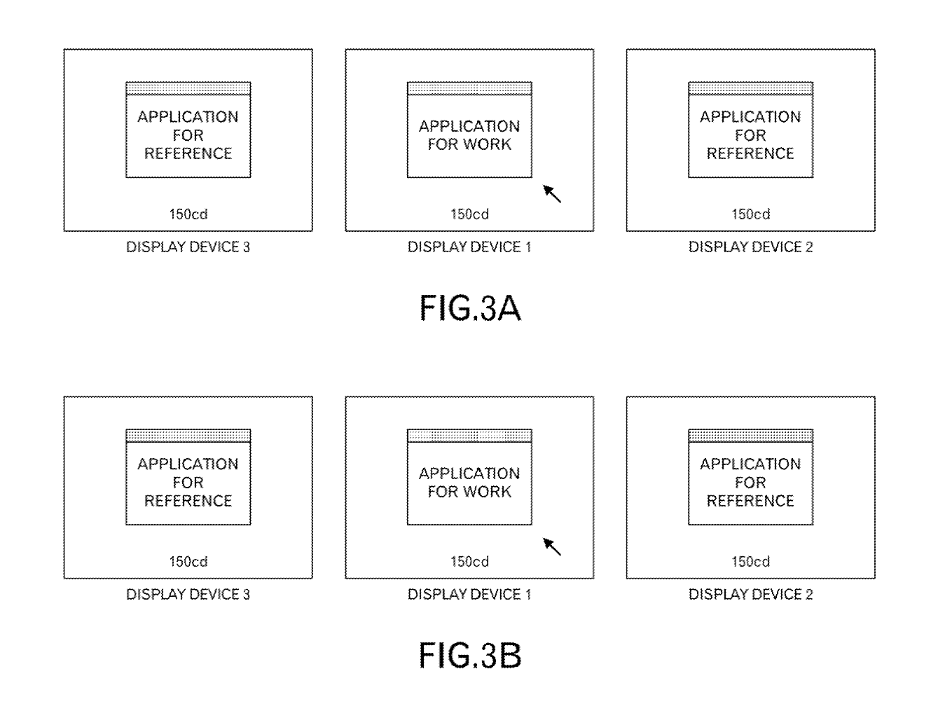

Therefore, as illustrated in FIG. 3A, when the window of the application for work and the mouse pointer are displayed on the display device 1, and the windows of the applications for reference are respectively displayed on the display device 2 and display device 3, the brightness of any windows are not lowered as illustrated in FIG. 3B, even after the predetermined period elapsed. Therefore, the user's convenience is not lowered.

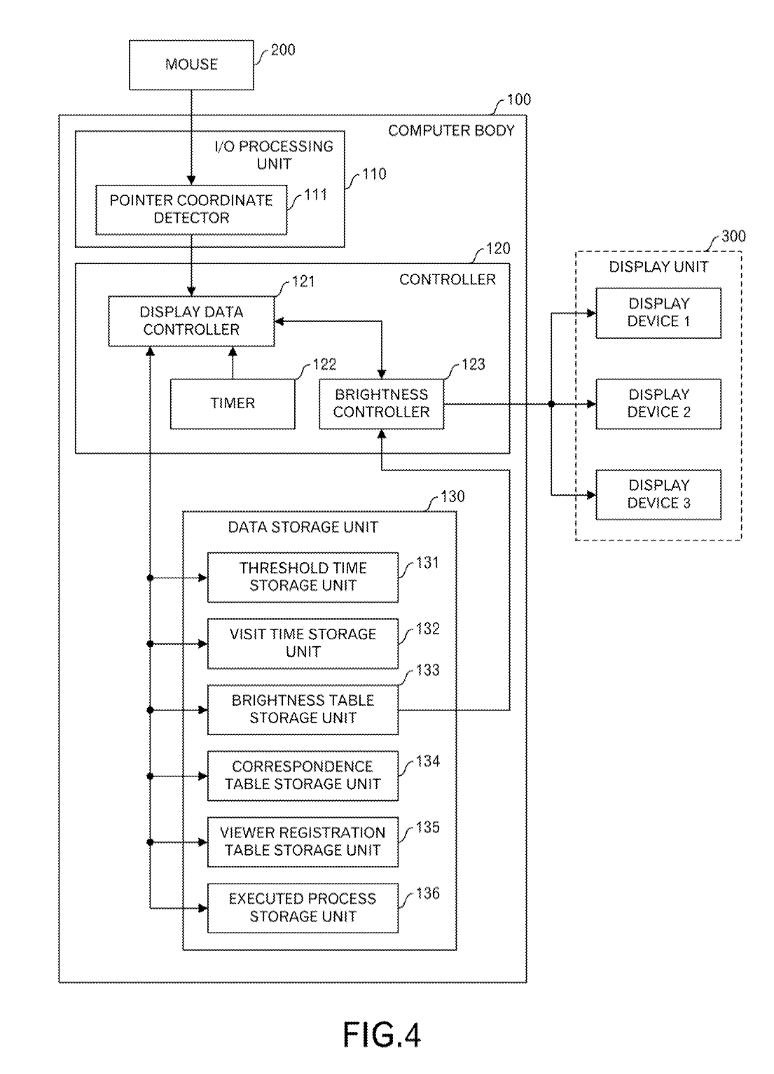

Next, a configuration of a computer to carry out the aforementioned display control will be explained by using FIGS. 4 to 16. The mouse 200 as an input device is connected to a computer body 100. Not only the mouse 200 but also a keyboard may be connected, however, in this embodiment, attention is paid to the mouse 200. Moreover, a display unit 300 is connected to the computer body 100, and the display unit 300 includes the display devices 1 to 3. The number of display devices is not restricted, if it is 2 or more.

In addition, the computer body 100 has an I/O processing unit 110, a controller 120 and a data storage unit 130. The I/O processing unit 110 has a pointer coordinate detector 111 to detect pointer coordinates from operations of the mouse 200. The pointer coordinate detector 111 outputs detected coordinate values of the mouse pointer to the controller 120.

Moreover, the controller 120 has a display data controller 121, a timer 122 and a brightness controller 123. The timer 122 has a function to output a present time. In addition, the display data controller 121 changes data of the data storage unit 130, and outputs instructions of the operations to the brightness controller 123. In response to an instruction from the display data controller 121, the brightness controller 123 carries out an operation to change the brightness of the display devices 1 to 3 included in the display unit 300 according to data of the brightness setting, which is stored in the data storage unit 130.

The data storage unit 130 includes a threshold time storage unit 131, a visit time storage unit 132, a brightness table storage unit 133, a correspondence table storage unit 134, a viewer registration table storage unit 135 and an executed process storage unit 136.

FIG. 5 illustrates an example of data stored in the threshold time storage unit 131. In an example of FIG. 5, a threshold time used in the processing described below is registered for each display device. However, when the same threshold time is used for all of the connected display devices, one value only has to be registered.

In addition, FIG. 6 illustrates an example of data stored in the visit time storage unit 132. In an example of FIG. 6, the visit time is registered for each display device. Typically, because the number of mice 200 is 1, the number of mouse pointers is 1. Therefore, an identifier of the display device on which the mouse pointer currently visits only has to be managed in association with the visit time. However, when data structure illustrated in FIG. 6 is used, a case where plural mice 200 are connected can be handled.

Furthermore, FIG. 7 illustrates an example of a brightness table stored in the brightness table storage unit 133. In an example of FIG. 7, a level of brightness being set, a level of default brightness, and a level of the brightness in non-visit state, which is the brightness when the mouse pointer does not visit (the level value is lower than the level value of the default brightness.) are registered. The default brightness and brightness in non-visit state are set in advance, and the level of the brightness instructed to the display device by the brightness controller 123 is registered as the brightness being set.

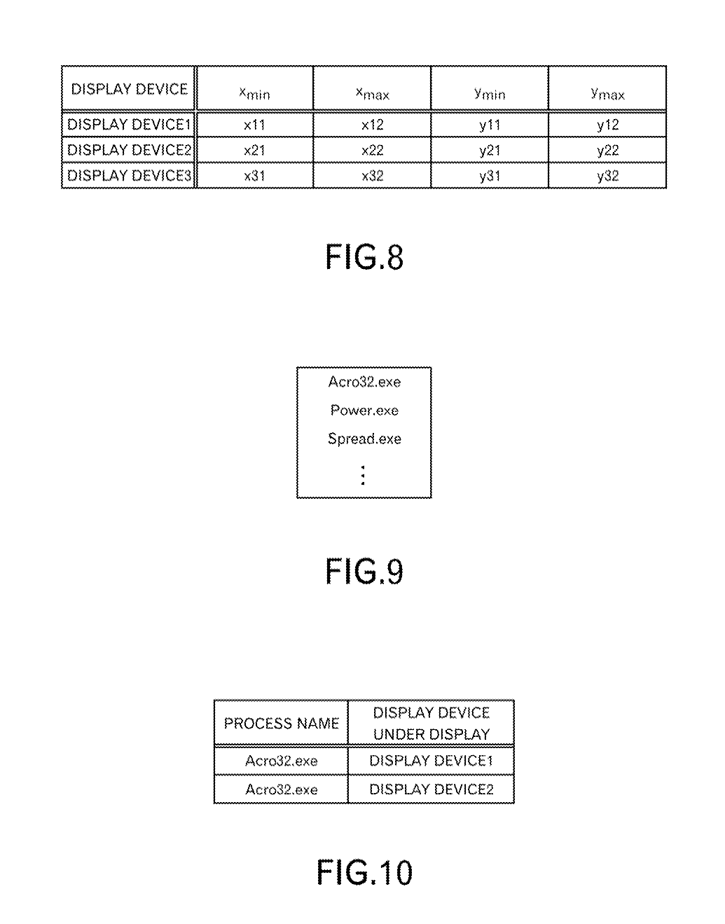

Moreover, FIG. 8 illustrates an example of a correspondence table stored in the correspondence table storage unit 134. In an example of FIG. 8, coordinate values (xₘᵢₙ, xₘₐₓ, Yₘᵢₙ, Yₘₐₓ) representing a range of a display screen on the display device for each display device are registered.

Furthermore, FIG. 9 illustrates an example of a viewer registration table stored in the viewer registration table storage unit 135. In an example of FIG. 9, names of programs that are determined as a viewer are registered.

Furthermore, FIG. 10 illustrates an example of data stored in the execution process storage unit 136. In an example of FIG. 10, identifiers of the display devices under display are registered for each program being executed.

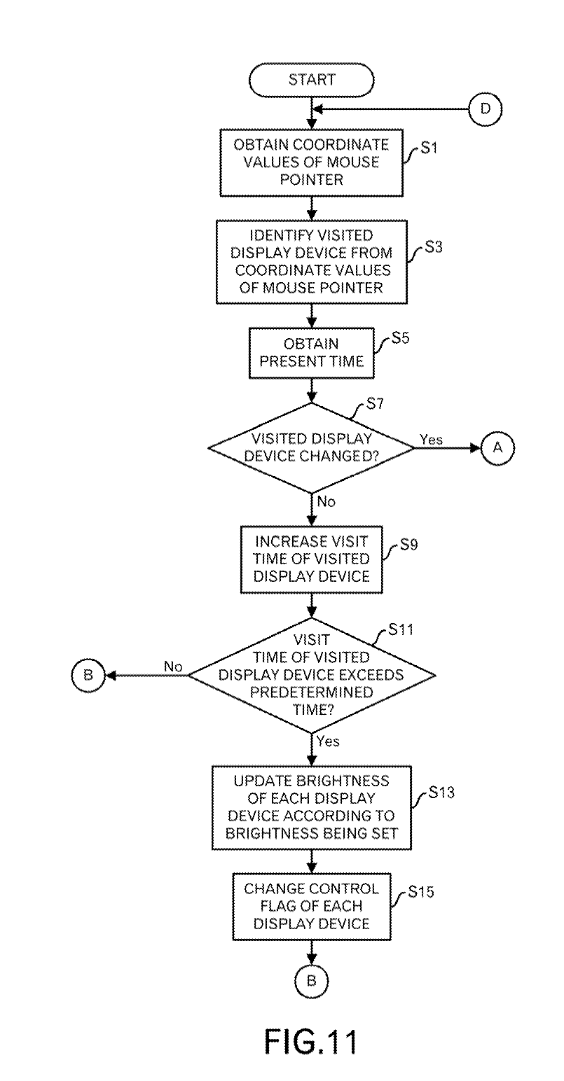

Next, operations of the apparatus illustrated in FIG. 4 will be explained by using FIGS. 11 to 16. First, the pointer coordinate detector 111 detects a mouse operation by the user, identifies the present coordinate values of the mouse pointer, and outputs the identified coordinate values to the display data controller 121. The display data controller 121 obtains the present coordinate values of the mouse pointer from the pointer coordinate detector 111 (FIG. 11: step S1). Then, the display data controller 121 identifies, as a pointer-visit display device (or simply, visited display device), a display on which the mouse pointer is currently displayed from the present coordinates of the mouse pointer and the correspondence table stored in the correspondence table storage unit 134 (step S3). As an example illustrated in FIG. 8, when the present coordinates are compared with the range of the display screen of each display device, it is possible to identify on what display screen of the display device the mouse pointer is displayed. An identifier of the pointer-visit display device is stored in a storage device such as a main memory. Moreover, the display data controller 121 obtains the present time from the timer 122 (step S5). This present time is also stored in the storage device such as a main memory.

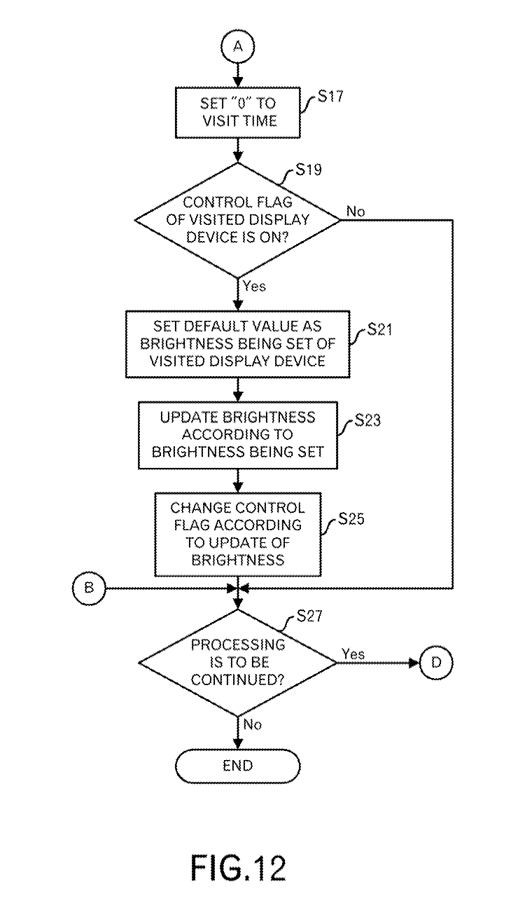

Then, the display data controller 121 determines whether or not the pointer-visit display device is changed (step S7). It is determined whether or not the visited display device identified at the step S3 is different from the visited display device, which was identified when the step S3 was previously executed. Incidentally, because the visited display device to be compared does not exist first time, it is determined that the visited display device is changed. When the visited display device is changed, the processing will be shifted to the processing of FIG. 12 through terminal A. Here, the processing of FIG. 12 will be explained first.

Shifting to the processing of FIG. 12, the display data controller 121 sets, as the visit time, “0” into the visit time storage unit 132 in association with the visited display device (step S17). Moreover, the display data controller 121 checks whether or not a control flag of the visited display device, which is managed by itself, is ON (step S19). In this embodiment, it is presumed that the control flag, for which ON is set when the brightness is controlled to be lowered, is managed by the display data controller 121. OFF is initially set to the control flag, and when the step S19 is firstly carried out, OFF has been set to the control flag.

When the control flag of the visited display device is OFF, the processing shifts to the step S27. On the other hand, when the control flag of the visited display device is ON, it means that the display device for which the brightness is controlled to be lowered once becomes a display device on which the mouse pointer visits. Therefore, the display data controller 121 sets a level value of the default brightness of the visited display device to the brightness being set of the visited display device in the brightness table in the brightness table storage unit 133 (step S21). Moreover, the display data controller 121 instructs the brightness controller 123 to carry out control, and in response to this instruction, the brightness controller 123 carries out the control so as to update the brightness of the display devices 1 to 3 according to the level values of the brightness being set in the brightness table (step S23). Incidentally, instead of the display devices 1 to 3, the brightness of only the display device on which the mouse pointer visits maybe updated according to the level value of the brightness being set in the brightness table. After the step S23 is carried out, the brightness controller 123 causes the display data controller 121 to change the control flags of the respective display devices according to the update of the brightness (step S25). OFF is set to at least the control flag for the display device on which the mouse pointer visits. Thus, a state is set that the level value of the default brightness is set as the brightness of the visited display device. Also here, OFF may be set only to the control flag of the visited display device.

Shifting to the step S27, the display data controller 121 determines whether or not the processing is to be continued (step S27). For example, the end of the processing is not instructed by the user, the display data controller 121 determines that the processing is to be continued, the processing returns to the step S1 in FIG. 11 through terminal D. On the other hand, the end of the processing is instructed, the processing ends.

By carrying out such a processing, when the processing is firstly executed, or when the display device at which the mouse pointer visits is changed, it is secured that the default brightness is set as the brightness of the display device at which the mouse pointer currently visits.

On the other hand, returning to the explanation of the processing of FIG. 11, when it is confirmed at the step S7 that the display device at which the mouse pointer visits does not change, the display data controller 121 increases the visit time for the visited display device in the visit time storage unit 132 by a difference between the present time obtained at the step S5 and time obtained when the step S5 was previously executed (step S9).

Then, the display data controller 121 determines whether or not the visit time for the visited display device exceeds a threshold time for the visited display device which is stored in the threshold time storage unit 131 (step S11). When the visit time of the mouse pointer on the visited display device does not exceed the threshold time of the visited display device, the current state is maintained. Therefore, the processing shifts to the step S27 in FIG. 12 through the terminal B.

On the other hand, when the visit time for the visited display device exceeds the threshold time for the visited display device, the display data controller 121 instructs the brightness controller 123 to carry out control, and in response to this instruction, the brightness controller 123 controls so as to update the brightness of each display device to the brightness being set of the display device in the brightness table in the brightness table storage unit 133 (step S13). Furthermore, the brightness controller 123 causes the display data controller 121 to set ON to a control flag for the display device to which the level value other than the level value of the default brightness is set, in other words the display device whose brightness is lowered, causes the display data controller 121 to set OFF to the control flag for the display device to which the level value of the default brightness, in other words, the display device whose brightness is not lowered (step S15). The processing shifts to the step S27 in FIG. 12 through the terminal B.

Thus, it becomes possible to identify the display device whose brightness is controlled to be lowered, by the control flag. Moreover, after the display device at which the mouse pointer visits does not change for the predetermined time, the brightness is changed, actually.

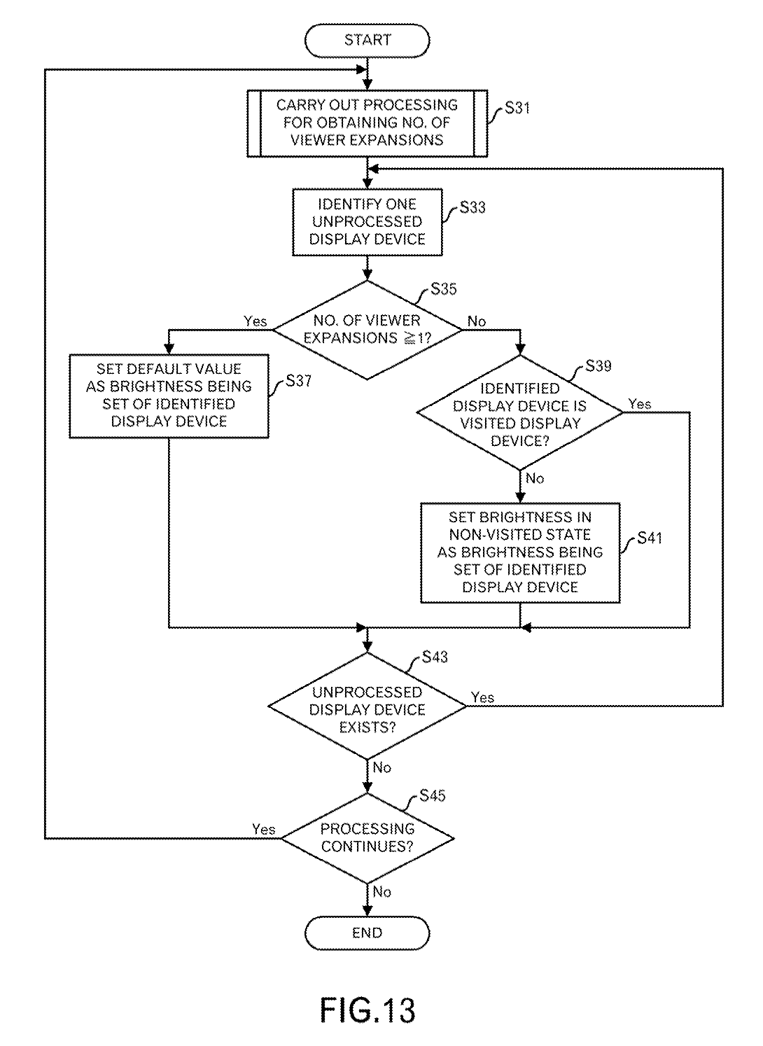

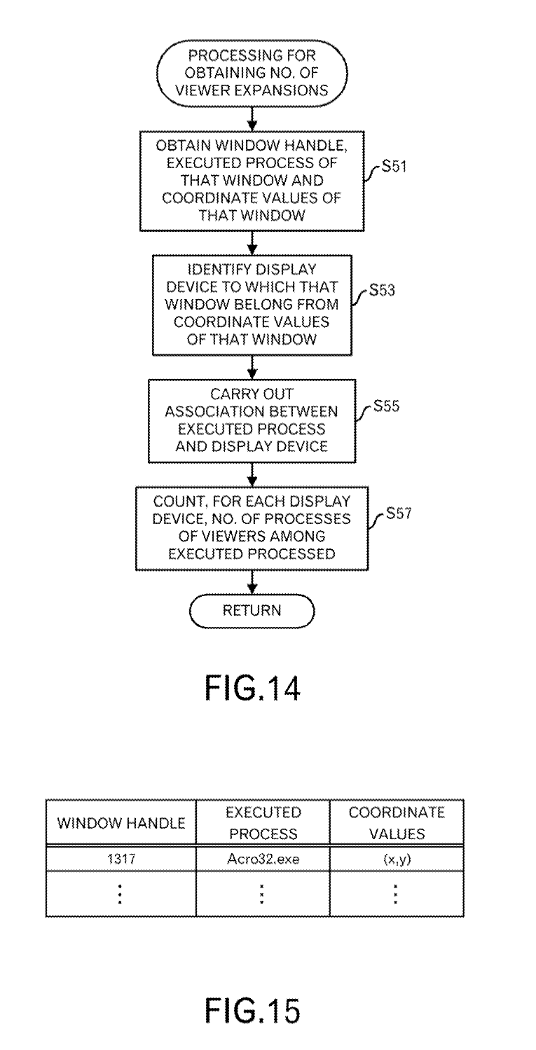

The processing flow illustrated in FIGS. 11 and 12 is a main processing flow representing control based on the display device at which the mouse pointer visits. However, in this embodiment, a processing illustrated in FIGS. 13 and 14 is carried out by another process carrying out the processing flow illustrated in FIGS. 11 and 12.

First, the display data controller 121 carries out a processing for obtaining the number of viewer expansions (FIG. 13: step S31). The processing for obtaining the number of viewer expansions will be explained by using FIGS. 14 to 16.

The display data controller 121 obtains a window handle, an executed process of that window and coordinate values of the window from an operating system in the computer body 100 (FIG. 14: step S51). The coordinate values of the window are coordinate values at the upper left of the window, for example. For example, data as illustrated in FIG. 15 is obtained. In an example of FIG. 15, the window handle, a name of the executed process of that window and coordinate values are obtained.

Next, the display data controller 121 identifies a display device to which the window belongs from the coordinate values of that window, according to the correspondence table (FIG. 8) in the correspondence table storage unit 134 (step S53). Then, the display data controller 121 carries out an association between the executed process and the display device, and stores the association data into the execution process storage unit 136 (FIG. 10) (step S55).

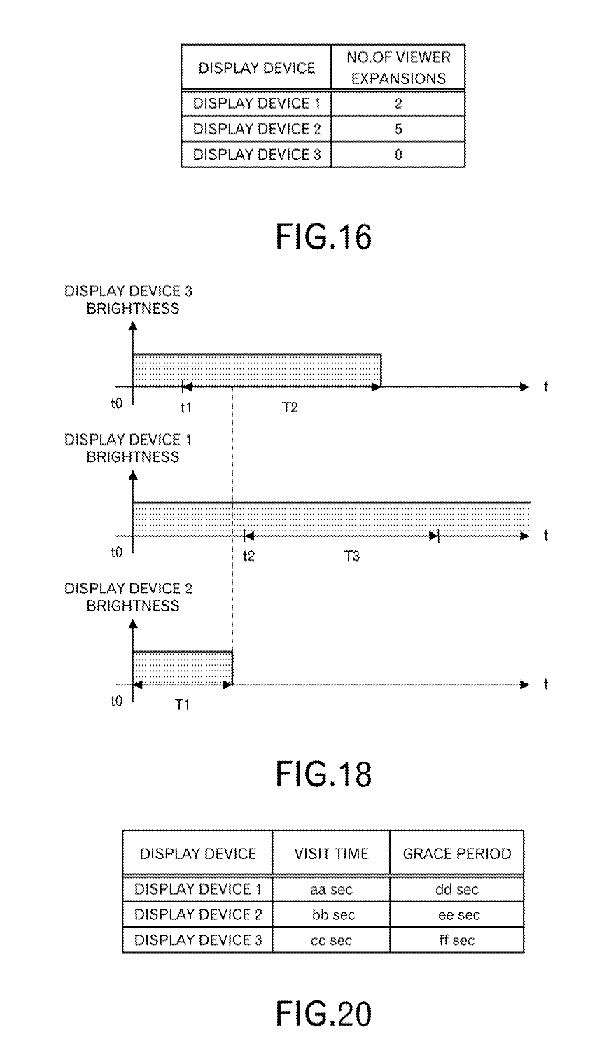

Then, the display data controller 121 counts, for each display device, the number of processes of the viewers among the executed processes, by using data stored in the executed process storage unit 136 and a viewer registration table in the viewer registration table storage unit 135, and stores the counted results into the storage device such as a main memory (step S57). Specifically, the executed processes registered in the executed process storage unit 136 are extracted for each display device, and it is checked whether or not the extracted executed processes have been registered in the viewer registration table. When it is registered, the count value is incremented. For example, data as illustrated in FIG. 16 is obtained. In an example, the number of processes registered as a viewer in the viewer registration table is registered for each display device, as the number of viewer expansions. Incidentally, instead of counting the number of processes, ON may be set to a flag for a display device on which even one pertinent process exists.

By doing so, it is possible to identify a display device on which a window of a viewer process is displayed.

Returning to the explanation of the processing in FIG. 13, the display data controller 121 identifies one unprocessed display device (step S33). Then, the display data controller 121 determines whether or not the number of viewer expansions for the identified display device is equal to or greater than “1” in the data as illustrated in FIG. 16 (step S35). When the number of viewer expansions for the identified display device is equal to or greater than “1”, the display data controller 121 sets the default brightness as the brightness being set for the identified display device in the brightness table (step S37). Then, the processing shifts to step S43.

On the other hand, when the number of viewer expansions for the identified display device is “0”, the display data controller 121 determines whether or not the identified display device is the display device at which the mouse pointer visits (step S39). It is determined based on data identified in the aforementioned processing flow (FIG. 11). Then, when the identified display device is the display device at which the mouse pointer visits, the processing shifts to the step S43. On the other hand, when the identified display device is not the display device at which the mouse pointer visits, the display data controller 121 sets the brightness in non-visit state as the brightness being set of the identified display device in the brightness table (step S41). Namely, a setting so as to lower the brightness is carried out. Then, the processing shifts to the step S43.

Then, at the step S43, the display data controller 121 determines whether or not there is an unprocessed display device (step S43). When there is an unprocessed display device, the processing returns to the step S33. On the other hand, when there is no unprocessed display device, the display data controller 121 determines whether or not the processing is to be continued (step S45). When the processing is to be continued, the processing returns to the step S31. On the other hand, when the processing is not to be continued, the processing ends.

Thus, it is possible to carry out a setting so as to lower the brightness for the display device on which no mouse pointer and no windows for processes registered as viewers are displayed. Namely, the brightness of the display device having no relationship with the user' s convenience is lowered. Accordingly, the energy saving is realized.

Incidentally, in the processing of FIG. 13, only the setting is carried out, and the update of the brightness is carried out according to the brightness being set in the processing of FIGS. 11 and 12. However, after the step S37 and S41, the brightness may be actually updated according to the brightness being set. Then, when a window of a new viewer is opened or closed, the adjustment of the brightness is carried out soon.

Moreover, instead of adjusting the brightness level, a setting of outputting the display data to the display device or stopping output of the display data may be made.

### Embodiment 2

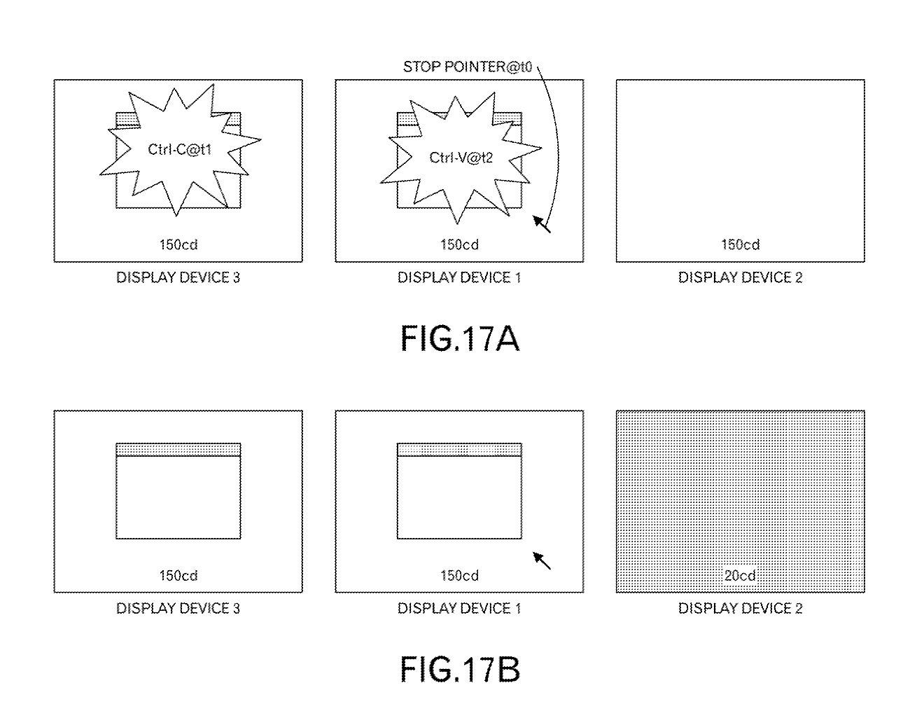

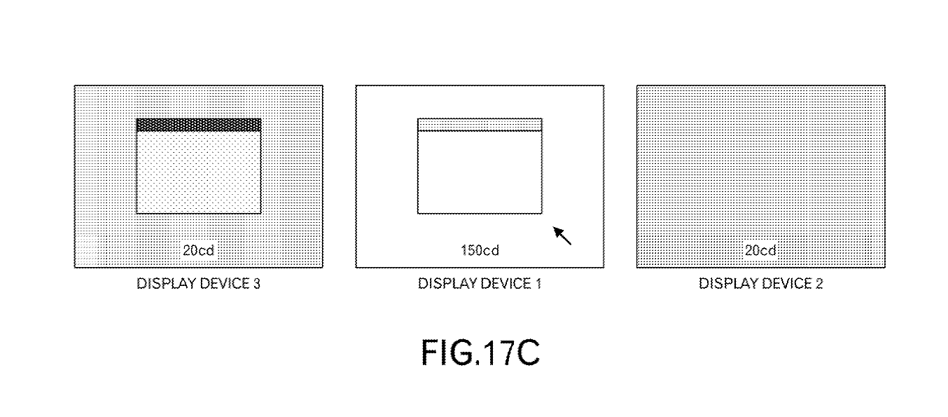

In the second embodiment, a following display control is carried out. Namely, as illustrated in FIG. 17A, it is presumed that, after a mouse pointer was placed on a display device 1 at time t0, a key operation to instruct copying such as “Ctrl-C” on a window displayed on a display device 3 was carried out at time t1, and furthermore, a key operation to instruct pasting such as “Ctrl-V” on a window displayed on the display device 1 was carried out at time t2. Incidentally, it is presumed that no windows and mouse pointer are displayed on a display device 2. Then, when time T1 elapsed since the time t0, for example, as illustrated in FIG. 17B, the brightness of the display device 2 on which no window and mouse pointer are displayed is lowered from 150 cd to 20 cd. On the other hand, the brightness of the display devices 1 and 3 is not lowered. After that, in case where no further operation or the like is not carried out for the display device 3 even when time T2 elapsed since the time t1, the brightness of the display device 3 is lowered from 150 cd to 20 cd, as illustrated in FIG. 17C, because it can be considered that the user no longer has any interest.

FIG. 18 illustrates a summary of such a display control. The top stage represents temporal variation of the brightness of the display device 3, the middle stage represents temporal variation of the brightness of the display device 1, and the bottom stage represents temporal variation of the brightness of the display device 2. As illustrated in the bottom stage, the brightness of the display device 2 is lowered after the time T1 elapsed since the time t0 when the visit of the mouse pointer at the display device 1 started. On the other hand, as for the display device 3, when any other noticeable key operation is not carried out by the elapse of the time T2 since the time t1 when the key operation to instruct the copying instead of the start of the visit of the mouse pointer, the brightness is lowered after the time T2 elapsed since the time t1. Furthermore, as for the display device 1, as long as the mouse pointer stays, the brightness is not lowered even when the time T3 elapsed since the key operation to instruct the pasting.

Incidentally, also in the embodiment, the lowering the brightness includes stopping output of display data to the display device from the computer.

Therefore, instead of using the simple determination reference based on the visit of the mouse pointer, by carrying out the lowering of the brightness based on a predetermined key operation for a display device displaying a window on which it is presumed that the user has an interest, (because the user carried out a noticeable key operation (maybe an operation of the mouse)), the lowering of the usability is suppressed and the energy saving is realized.

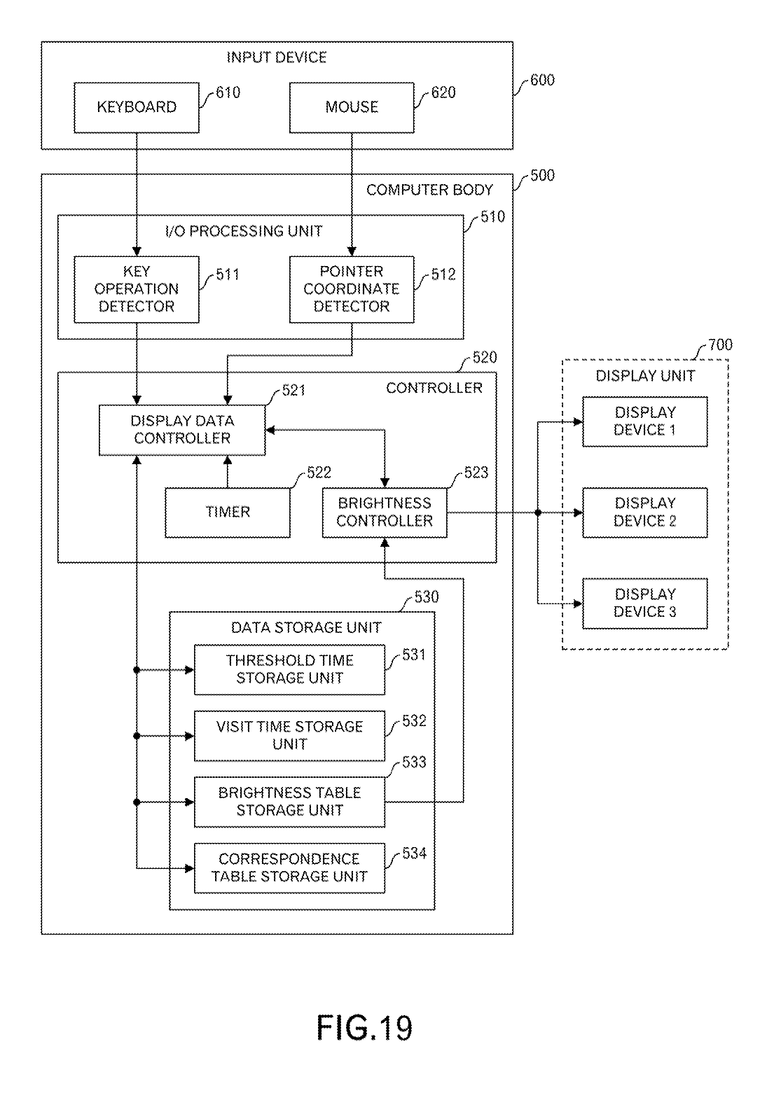

Next, by using FIGS. 19 to 25, a configuration of a computer to carry out the aforementioned display control will be explained. An input device 600, a keyboard 610 and a mouse 620 are connected to a computer body 500. In addition, a display unit 700 is connected to the computer body 500, and the display unit 700 includes display devices 1 to 3. The number of display devices is not restricted, as long as the number of display devices is 2 or more.

In addition, the computer body 500 has an I/O processing unit 510, a controller 520 and a data storage unit 530. The I/O processing unit 510 has a key operation detector 511 to detect predetermined key operations (e.g. key operations for copying (including “cutting” in this embodiment) and paste) from operations of the keyboard 610, and a pointer coordinate detector 512 to detect pointer coordinates from operations of the mouse 620. When a predetermined key operation is detected, the key operation detector 511 notifies the controller 520 of the detection. In addition, the pointer coordinate detector 512 outputs coordinate values of the detected mouse pointer to the controller 520. Incidentally, the pointer coordinate detector 512 may detect instructions of operations of the copying and pasting by the mouse 620, and output data of the detection to the controller 520.

Moreover, the controller 520 has a display data controller 521, a timer 522 and brightness controller 523. The timer 522 has a function to output the present time. In addition, the display data controller 521 changes data of the data storage unit 530, and outputs instructions of operations to the brightness controller 523. In response to the instruction from the display data controller 521, the brightness controller 523 carries out operations to change the brightness of the display devices 1 to 3 included in the display unit 700 according to data of the brightness setting, which is stored in the data storage unit 530.

The data storage unit 530 includes a threshold time storage unit 531, a visit time storage unit 532, a brightness table storage unit 533 and a correspondence table storage unit 534. Incidentally, the storage units other than the visit time storage unit 532 are the same as those in the first embodiment. FIG. 20 illustrates an example of data stored in the visit time storage unit 532. In an example of

FIG. 20, a visit time and a grace period until the lowering of the brightness are registered for each display device. For example, when the operation for the copying is detected, a predetermined period is set as the grace period, and the count-down begins. The predetermined period may be different between the copying and the pasting.

Moreover, typically, when there is one mouse 620, there is one mouse pointer. Therefore, an identifier of the display device on which the mouse pointer currently visits and the visit time only has to be associated for the management. However, as long as the data structure illustrated in FIG. 20 is adopted, a case where plural mice 620 are connected can be handled.

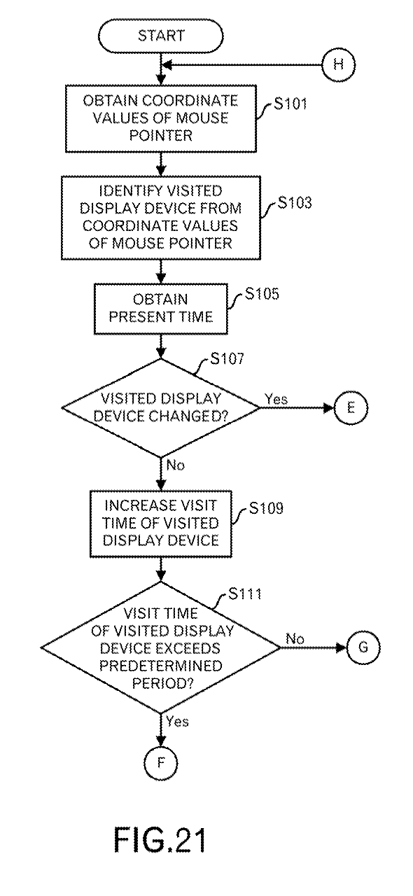

Next, operations of the apparatus illustrated in FIG. 19 will be explained by using FIGS. 21 to 25. First, the pointer coordinate detector 512 detects a mouse operation by the user to identify the current coordinate values of the mouse pointer, and outputs the coordinate values to the display data controller 521. The display data controller 521 obtains the current coordinate values of the mouse pointer from the pointer coordinate detector 512 (step S101). Then, the display data controller 521 identifies, as a pointer-visit display device (also called visited display device), one display device on which the mouse pointer is currently displayed from the current coordinate values of the mouse pointer and the correspondence table stored in the correspondence table storage unit 534 (step S103). An identifier of the display device on which the mouse pointer stays is stored in a storage device such as a main memory. Moreover, the display data controller 521 obtains the present time from the timer 522 (step S105). Data of this present time is also held in the storage device such as the main memory.

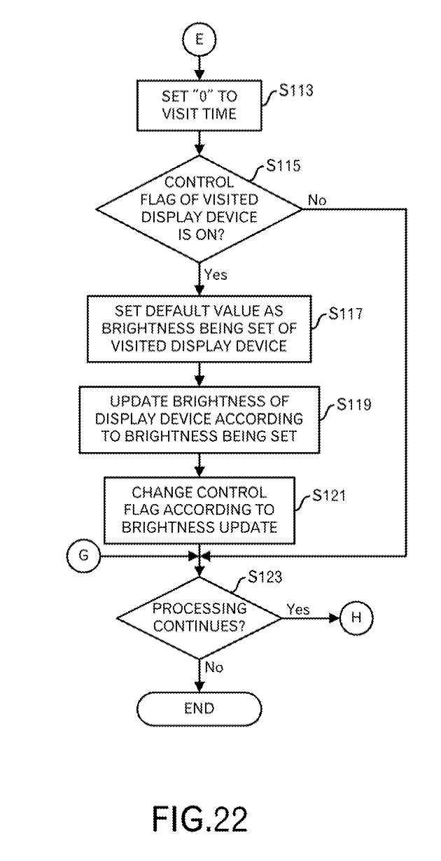

Then, the display data controller 521 determines whether or not the pointer-visit display device changes (step S107). At this step, it is determined whether or not the visited display device identified at the step S103 is different from the visited display device identified when the step S103 was previously executed. Incidentally, because the visited display device to be compared does not firstly exist, it is determined that the pointer-visit display device was changed. When the pointer-visit display device was changed, the processing shifts to the processing of FIG. 22 through terminal E. Here, the processing of FIG. 22 will be explained, previously.

Shifting to the processing of FIG. 22, the display data controller 521 sets “0” as the visit time in the visit time storage unit 532 in association with the visited display device (step S113). Moreover, the display data controller 521 checks whether or not ON is set to a control flag, which is managed by itself, for the visited display device (step S115). In this embodiment, it is presumed that the display data controller 521 manages control flags that ON is set when the brightness is controlled to be lowered, for the respective display devices. Initially, OFF is set to the control flag, and when the step S115 is firstly executed, OFF has been set to the control flags.

When the control flag of the visited display device is OFF, the processing shifts to step S123. On the other hand, when the control flag of the visited display device is ON, it means that the display device whose brightness was controlled to be lowered once becomes a display device at which the mouse pointer visits. Therefore, the display data controller 521 sets the level value of the default brightness of that visited display device as the brightness being set of that visited display device in the brightness table of the brightness table storage unit 533 (step S117). Moreover, the display data controller 521 instructs the brightness controller 523 to carry out control, and the brightness controller 523 controls so as to update the brightness of the display devices 1 to 3 according to the level values of the brightness being set in the brightness table (step S119). Incidentally, instead of the display devices 1 to 3, only the brightness of the pointer-visit display device may be updated according to the level value of the brightness being set in the brightness table. When the step S119 was executed, the brightness controller 523 causes the display data controller 521 to change the control flags of the respective display devices according to this brightness update. OFF is set to at least the control flag of the pointer-visit display device. By doing so, a setting is made so that the brightness of the visited display device becomes the level value of the default brightness. Here, OFF may be set only to the control flag of the pointer-visit display device.

Shifting to the step S123, the display data controller 521 determines whether or not the processing is to be continued (step S123). For example, when the user does not instruct the end of the processing, it is determined that the processing is to be continued, and the processing returns to the step S101 in FIG. 21 through terminal H. On the other hand, when the end of the processing is instructed, the processing ends.

By carrying out such a processing, when it is firstly executed or when the pointer-visit display device is changed, it is secured that the default brightness is set as the present brightness of the pointer-visit display device.

On the other hand, returning to the explanation of the processing of FIG. 21, when it is confirmed at the step S107 that the pointer-visit display device was not changed, the display data controller 521 increments the visit time for the visited display device by a difference between the present time obtained at the step S105 and a time obtained when the step S105 was previously executed (step S109).

Then, the display data controller 521 determines whether or not the visit time of the visited display device exceeds the threshold time for that visited display device (step S111). When the visit time of the mouse pointer on the visited display device does not exceed the threshold time of that visited display device, the processing shifts to step S123 of FIG. 22 through terminal G, as an operation to maintain the present state.

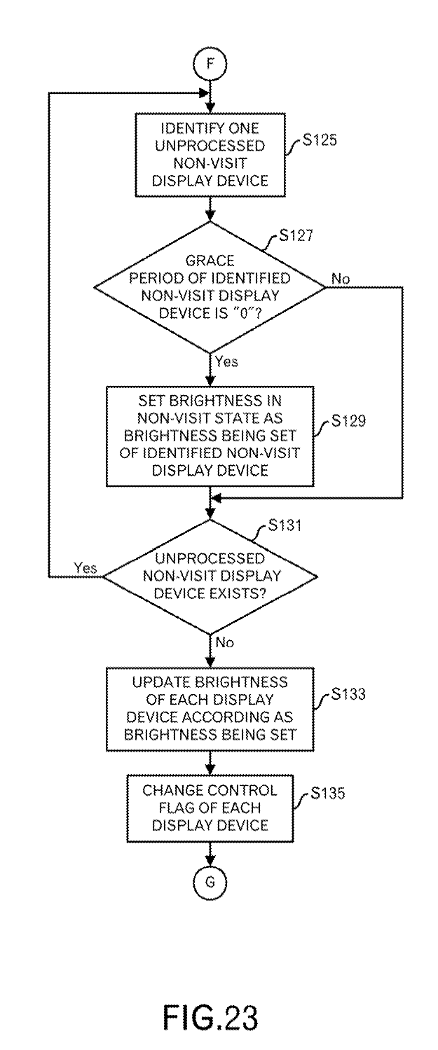

On the other hand, when the visit time for the visited display device exceeds the threshold time for that visited display device, the processing shifts to a processing of FIG. 23 through the terminal F.

The display data controller 521 identifies one unprocessed non-visit display device at which the mouse pointer does not visit (step S125). Then, the display data controller 521 checks whether or not the grace period becomes “0” for the identified non-visit display device in the visit time storage unit 532 (step S127). By carrying out such a processing, it is determined whether or not it is a display device at which the mouse pointer does not visit and from or onto which any operation for the copying or pasting is not carried out. When it is such a display device, the display data controller 521 sets the brightness in non-visit state of the mouse pointer as the brightness being set for the identified non-visit display device (step S129). Then, the processing shifts to step S131. On the other hand, when the grace period of the identified non-visit display device is not “0”, the processing shifts to the step S131, because the brightness cannot be adjusted.

Shifting to the step S131, the display data controller 521 determines whether or not there is any unprocessed non-visit display device (step S131). When there is an unprocessed non-visit display device, the processing returns to the step S125. On the other hand, when there is no unprocessed non-visit display device, the display data controller 521 outputs an instruction to the brightness controller 523, and in response to this instruction, the brightness controller 523 controls so as to update the brightness of the respective display devices according to the brightness being set in the brightness table (step S133).

Furthermore, the brightness controller 523 causes the display data controller 521 to set ON to the control flag for the display device for which the level value other than the level value of the default brightness is set, in other words, for the display device whose brightness is lowered, and causes the display data controller 521 to set OFF to the control flag for the display device for which the level value of the default brightness is set, in other words, for the display device whose brightness is not lowered (step S135). The processing shifts to the step S123 of FIG. 22 through the terminal G.

By carrying out such a processing, the change of the brightness is carried out based on the pointer-visit display device. Specifically, the brightness of the display device at which the mouse pointer visits is heightened, and the brightness of the display devices at which the mouse pointer does not visit and which does not relate to the operation for the copying or pasting is lowered. Thus, the user' s convenience is not influenced, and the energy saving is realized.

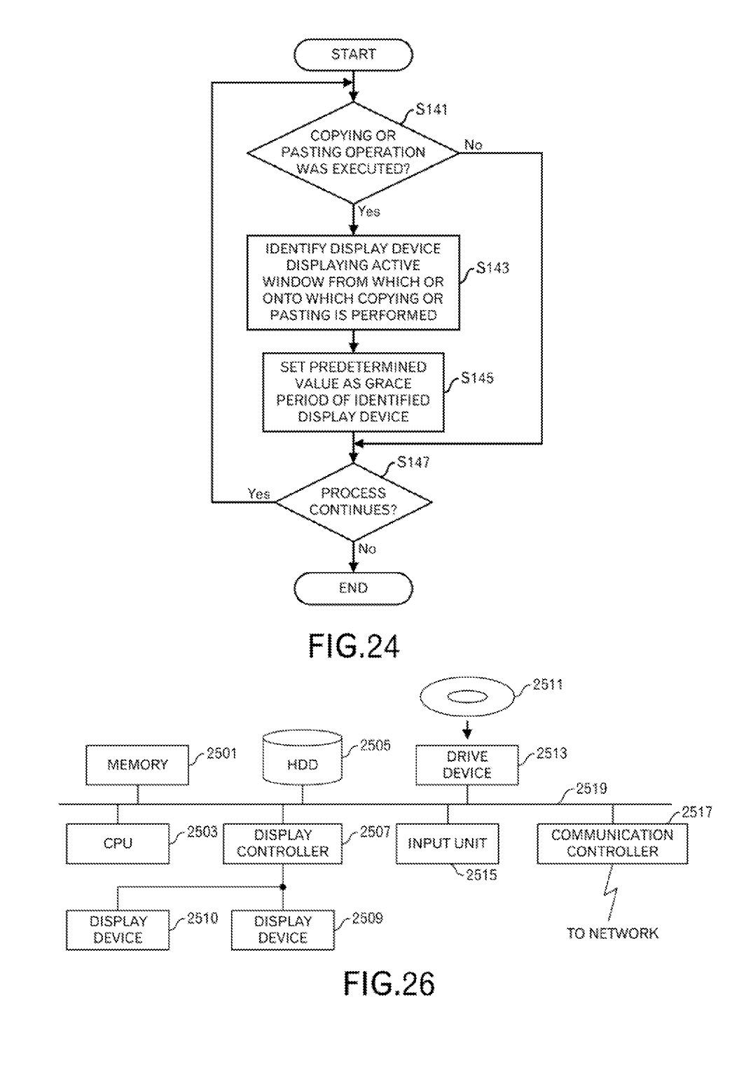

Next, contents of a process executed, as another process, separately from the processing flows of FIGS. 21 to 23 will be explained by using FIG. 24. The key operation detector 511 or the like determines whether or not the operation of the copying or pasting was carried out (step S141). When any operation for the copying or pasting is not detected, the processing shifts to the step S147. On the other hand, when the operation for the copying or pasting is detected, the detection is notified to the display data controller 521, and in response to the notification, the display data controller 521 identifies a display device displaying an active window from or onto which the copying or pasting was carried out (step S143). For example, the display data controller 521 obtains the coordinate values of the active window, searches the correspondence table in the correspondence table storage unit 534 by the obtained coordinate values, for example, and identifies the display device in which the coordinate values of the active window is included.

Then, the display data controller 521 sets a predetermined time as the grace period of the identified display device in the visit time storage unit 532 (step S145). The different predetermined times may be set for the respective display device, or a common value may be set. Then, the processing shifts to step S147.

When the processing shifts to the step S147, the display data controller 521 determines whether or not the processing is to be continued (step S147), and when the processing is to be continued, the processing returns to the step S141, and when the processing is not to be continued, the processing ends.

Because the step S145 is carried out for each detection of the operation for the copying or pasting, the grace period is updated to the initial value every time when such an operation is carried out.

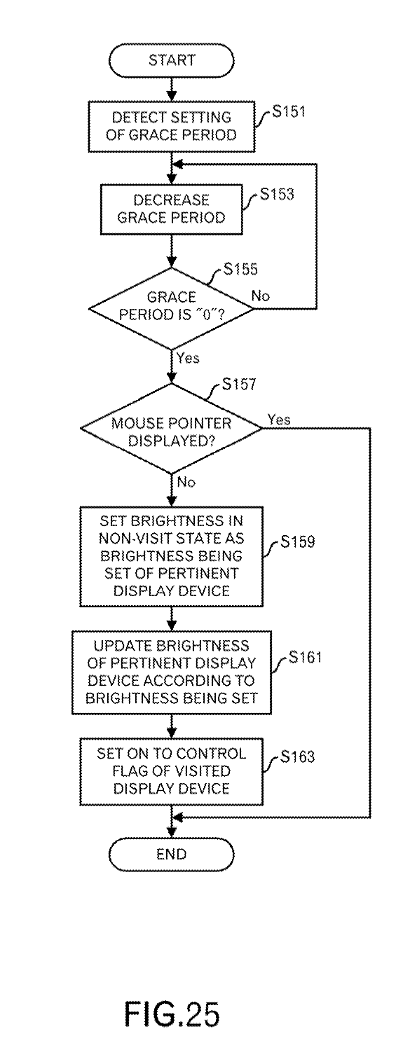

Moreover, contents of a process executed as another process, separately from the processing of FIGS. 21 to 24 will be explained by using FIG. 25. Incidentally, the processing of FIG. 25 is carried out for each display device. First, when the display data controller 521 detects the setting of the grace period by the process that carries out the processing of FIG. 24 (step S151), and subtracts a difference between the present time obtained from the timer 522 and the previously obtained time from the grace period in the visit time storage unit 532 (step S153). Then, the display data controller 521 determines whether or not the grace period becomes “0” (step S155). When the grace period is not “0”, the processing returns to the step S153. Incidentally, because the value of the grace period returns to the initial value in FIG. 24, the grace period may not be monotonically decreased.

On the other hand, when the grace period becomes “0”, the display data controller 521 determines whether or not the mouse pointer stays on the display device relating to the processing (step S157). This is determined from the coordinate values of the mouse pointer from the pointer coordinate detector 512 and data in the correspondence table storage unit 534.

When the mouse pointer stays on the display device relating to the processing, the change of the brightness cannot be carried out in this processing. Therefore, the processing ends. On the other hand, when the mouse pointer does not stay on the display device relating to the processing, the display data controller 521 sets the brightness in non-visit state as the brightness being set of the pertinent display device in the brightness table in the brightness table storage unit 533 (step S159). In addition, the display data controller 521 instructs the brightness controller 523, and in response to this instruction, the brightness controller 523 controls so as to update the brightness of the pertinent display device according to the brightness being set (step S161). Furthermore, the brightness controller 523 causes the display data controller 521 to set ON to the control flag of the pertinent display device for which the level value other than the level value of the default brightness is set, in other words, whose brightness is lowered (step S163). Then, the processing ends.

Thus, when the grace period of the display device at which the mouse pointer does not visit elapsed, the brightness of that display device is lowered. Accordingly the energy saving is realized. In case where the mouse pointer is not placed when the grace period elapsed or in case where a next operation for the copying or pasting is not carried out, it is considered that the convenience of the user is not lowered.

Thus, the user's convenience is not lowered in this second embodiment, and the energy saving is achieved.

Although the embodiments of this technique were explained, this technique is not limited these embodiments. For example, the functional block diagrams illustrated in FIG. 4 and FIG. 19 are mere examples, and do not always correspond to actual program module configurations. The data storage unit configurations are mere examples, and another data storage mode may be adopted.

Moreover, the aforementioned processing flows are mere examples, and as long as the processing results are not changed, the order of the steps may be exchanged, and the steps may be executed in parallel.

In addition, the computer bodies 100 and 500 are computer device as shown in FIG. 26. That is, a memory 2501 (storage device), a CPU 2503 (processor), a hard disk drive (HDD) 2505, a display controller 2507 connected to display devices 2509 and 2510, a drive device 2513 for a removable disk 2511, an input device 2515, and a communication controller 2517 for connection with a network are connected through a bus 2519 as shown in FIG. 26. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

Incidentally, when a configuration is adopted that the brightness is changed the brightness can be controlled by I2C signal line, if the display controller 2507 and display devices 2509 and 2510 adopt Display Data Channel Command Interface (DDC/CI) in Video Electronics Standards Association (VESA), for example. On the other hand, when a configuration is adopted that output of the display data is stopped in order to lower the brightness, it is possible even if the analog interface or digital interface is adopted.

The aforementioned embodiments are summarized as follows:

A display control method relating to a first aspect of this embodiment includes (A) checking, for each of plural display devices connected to a computer, whether or not a window of a predetermined program registered in advance in a data storage unit is displayed; and (B) carrying out a setting for lowering of brightness of a first display device on which a pointer of a mouse connected to the computer is not displayed among display devices on which a window of the predetermined program is not displayed.

In case where a work is conducted while referring to a window of the predetermined program, the brightness should not be lowered even when the mouse pointer is not placed on the display device displaying the window. Therefore, any setting for lowering the brightness of the display device displaying the window of the predetermined program is not carried out to consider the usability. More specifically, for example, the predetermined brightness is set as the brightness of the display device on which the window of the predetermined program is displayed. On the other hand, the brightness of the display device on which the window of the predetermined program is not displayed and on which the mouse pointer is not displayed is lowered to realize the energy saving.

In addition, the display control method relating to the first aspect may further include: changing the brightness of the first display device according to the aforementioned setting, after it is confirmed that a display device on which the pointer of the mouse is displayed is not changed for a predetermined period. The timing of the change of the brightness may be a timing when the display device on which the pointer of the mouse is displayed is not changed for the predetermined period or may be carried out soon.

Furthermore, the aforementioned setting may be a setting for stopping output of display data to the first display device. The adjustment of the brightness level may be conducted or the display itself may be stopped.

In addition, the display control method relating to the first aspect of these embodiments may further include: determining whether or not brightness of a second display device on which the pointer of the mouse is currently displayed is lowered according to the aforementioned setting, upon detecting that a display device on which the pointer of the mouse was changed; and getting back the brightness of the second display device to predetermined brightness, when the brightness of the second display device is lowered according to the setting. When the display device displaying the pointer of the mouse was changed, the brightness of the display device is gotten back soon to prevent from lowering the usability.

A display control method relating to a second aspect of these embodiments includes: (A) first detecting a predetermined operation for an active window displayed on any one of plural display devices connected to a computer; (B) identifying a first display device on which the active window is displayed; and (C) carrying out a setting for lowering brightness of the first display device, upon detecting that a pointer of a mouse is not displayed on the first display device after a predetermined period elapsed since the first detecting.

Typically, the window for which a user conducts an operation, for example, for a copying or pasting is a window to which the user pays attention, regardless of the presence or absence of the mouse pointer. Therefore, after the operation, the user may reference the window for a while. Therefore, when the aforementioned processing is carried out, the user's convenience is not lowered and the energy saving is realized.

Moreover, the display control method relating the second aspect of these embodiments may further include: after it is confirmed that the display device on which the pointer of the mouse is displayed is not changed for a predetermined period, determining whether or not the predetermined period is being measured for any display device included in the plural display device; and carrying out a setting for lowering the brightness of the display device for which the predetermined period is not being measured and on which the pointer of the mouse is not displayed. Thus, because it is not the display device on which the mouse pointer is not displayed and the window that is a target of the aforementioned operation is not displayed, it hardly influences user's convenience. Therefore, by lowering the brightness, the energy saving is realized.

Furthermore, the aforementioned setting may be a setting for stopping output of display data to the first display device. The adjustment of the brightness level maybe carried out or the display itself may be stopped.

Moreover, the display control method relating to the second aspect of the embodiments may include: upon detecting that the display device displaying the pointer of the mouse was changed, determining whether or not the brightness of a second display device on which the pointer of the mouse is currently displayed is lowered according to the aforementioned setting; and getting back the brightness of the second display device to predetermined brightness, when the brightness of the second display device is lowered according to the aforementioned setting. When the display device displaying the pointer of the mouse was changed, the brightness of that display device is gotten back soon to prevent from lowering the usability.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a procedure comprising:
detecting a case where at least both of a condition that a pointer representing a pointing destination by a pointing device is not displayed on one display device of a plurality of display devices and a condition that a window generated by a predetermined program is not displayed on the one display device are satisfied; and
upon the detecting, lowering brightness of the one display device.

2. The computer-readable, non-transitory storage medium as set forth in claim 1, wherein the lowering is carried out after it is confirmed that a display device on which the pointer is displayed does not change for a predetermined period.

3. The computer-readable, non-transitory storage medium as set forth in claim 1, wherein the lowering is carried out by stopping output of display data to the one display device.

4. The computer-readable, non-transitory storage medium as set forth in claim 1, wherein the procedure further comprises:
determining whether brightness of a second display device on which the pointer is currently displayed is lowered, upon detecting the display device on which the pointer is displayed is changed; and
upon detecting that the brightness of the second display device is lowered, getting back the brightness of the second display device to predetermined brightness.

5. The computer-readable, non-transitory storage medium as set forth in claim 1, wherein the procedure further comprises:
making brightness of a display device on which a window generated by the predetermined program is displayed predetermined brightness.

6. A computer-readable, non-transitory storage medium storing a program for causing a computer to execute a procedure comprising:
first detecting a predetermined operation for an active window displayed on any one display device among a plurality of display devices connected to the computer;
identifying a first display device on which the active window is displayed;
second detecting that a pointer representing a pointing destination by a pointing device is not displayed on the first display device after a predetermined period elapsed since the first detecting; and
upon the second detecting, carrying out a setting for lowering brightness of the first display device.

7. The computer-readable, non-transitory storage medium as set forth in claim 6, wherein the procedure comprises:
determining whether a predetermined period is being measured for any one of the plurality of display devices, after it is confirmed that a display device on which the pointer is displayed is not changed for a predetermined period; and
carrying out a setting for lowering the brightness of a display device for which the predetermined period is not being measured and on which the pointer is not displayed.

8. The computer-readable, non-transitory storage medium as set forth in claim 6, wherein the setting is a setting for stopping output of display data to the first display device.

9. The computer-readable, non-transitory storage medium as set forth in claim 6, wherein the procedure comprises:
determining whether brightness of a second display device on which the pointer is currently displayed is lowered, after detecting that the display device on which the pointer is displayed is changed; and
upon detecting that the brightness of the second display device is lowered, getting back the brightness of the second display device to predetermined brightness.

10. A display control method comprising:
detecting, by using a computer, a case where at least both of a condition that a pointer representing a pointing destination by a pointing device is not displayed on one display device of a plurality of display devices and a condition that a window generated by a predetermined program is not displayed on the one display device are satisfied; and
upon the detecting, lowering, by using the computer, brightness of the one display device.

11. A display control method comprising:
first detecting, by using a computer, a predetermined operation for an active window displayed on any one display device among a plurality of display devices connected to the computer;
identifying, by using the computer, a first display device on which the active window is displayed;
second detecting, by using the computer, that a pointer representing a pointing destination by a pointing device is not displayed on the first display device after a predetermined period elapsed since the first detecting; and
upon the second detecting, carrying out, by using the computer, a setting for lowering brightness of the first display device.

12. A display control apparatus comprising:
a memory; and
a processing unit using the memory and configured to a procedure comprising:
detecting a case where at least both of a condition that a pointer representing a pointing destination by a pointing device is not displayed on one display device of a plurality of display devices and a condition that a window generated by a predetermined program is not displayed on the one display device are satisfied; and
upon the detecting, lowering brightness of the one display device.

13. A display control apparatus comprising:
a memory; and
a processing unit using the memory and configured to a procedure comprising:
first detecting a predetermined operation for an active window displayed on any one display device among a plurality of display devices connected to the computer;
identifying a first display device on which the active window is displayed;
second detecting that a pointer representing a pointing destination by a pointing device is not displayed on the first display device after a predetermined period elapsed since the first detecting; and
upon the second detecting, carrying out a setting for lowering brightness of the first display device.
